(19) United States
(12) Patent Application Publication
(10) Pub. No.: US 2009/0271594 A1
(43) Pub. Date: Oct. 29, 2009

(54) SEMICONDUCTOR INTEGRATED CIRCUIT, SEMICONDUCTOR INTEGRATED CIRCUIT CONTROL DEVICE, LOAD DISTRIBUTION METHOD, LOAD DISTRIBUTION PROGRAM, AND ELECTRONIC DEVICE

(76) Inventors: Hiroako Inoue, Tokyo (JP); Masamichi Takagi, Tokyo (JP); Masayuki Mizuno, Tokyo (JP)

Correspondence Address: NEC CORPORATION OF AMERICA, 6535 N. STATE HWY 161, IRVING, TX, 75039, US

(21) Appl. No.: 12/517,986

(22) PCT Filed: Nov. 22, 2007
(86) PCT No.: PCT/JP2007/072694

§ 371 Date: Jun. 5, 2009

(51) Int. Cl. G06F 9/302; G06F 9/30

(52) U.S. Cl. 712/228; 712/E09.016; 712/E09.017

(57) ABSTRACT

A damage control unit includes: a switching judgment unit to judge the CPU configuration which performs smoothing of the damage ratio, according to the damage ratio of the CPUs; and a switching unit to perform switching of I/O signals of all the CPUs. The switching judgment unit observes the damage ratio calculated from values such as the temperature, voltage, current consumption amount, operation ratio, the number of accesses to the resources in the CPU, at all times or at some extent of time intervals and notifies the switching unit of the CPU configuration to be changed by using the calculation method for smoothing the damage ratio of each CPU. The switching unit makes a connection to the I/O signals of all the CPUs and a system bus and switches the I/O signal of the CPU to be switched according to the notification from the switching judgment unit.

### TECHNICAL FIELD

The present invention relates to a semiconductor integrated circuit including a plurality of CPUs, and more particularly, to a semiconductor integrated circuit, a semiconductor integrated circuit control device, a load distribution method, a load distribution program, and an electronic device capable of improving the reliability of the semiconductor integrated circuit by damage control at the time of a wear-out failure.

### BACKGROUND ART

Thanks to the development of miniaturization of semiconductors, semiconductor integrated circuits have been enjoying a benefit of performance enhancement. However, since the increase in the load on the semiconductor integrated circuits, such as the current density or the number of times of switching of the circuit, involved in the performance enhancement imposes an extremely heavy burden on semiconductor devices, the semiconductor devices cannot avoid becoming fatigued, so that the useful lives thereof are shortened.

FIG. 1 is a background art view schematically showing an example of a structure example of a damage control device by load distribution at application level. In the structure example of the damage control device shown in FIG. 1, applications (AP) 30P1 to 30Pm run on execution environments 40P1 to 40Pn including CPUs 10P1 to 10Pn and OSs 20P1 to 20Pn.

In such a structure, the OSs 20P1 to 20Pn control the load conditions of the CPUs so as to become fixed, such as moving an application onto a different CPU, according to the loads on the applications 30P1 to 30Pn. Since the fatigues (loads) of the CPUs 10P1 to 10Pn are smoothed by this control, the useful lives of the semiconductor devices can be prolonged.

However, the conventional method shown in FIG. 1 has the following problems:

Firstly, when there is an application or the like fixedly assigned to a CPU for the load distribution at application level, it is difficult to smooth the loads on the CPUs.

Secondly, the load measurement at application level is not directly related to the degree of fatigue (damage ratio) of the CPU.

An example of a technique to handle these is a task assignment method as described in Patent Reference 1 (Japanese Unexamined Patent Application Publication No. S62-075739). However, Patent Reference 1 discloses a task load distribution method capable of fixedly assigning a task as well like the structure shown in FIG. 1 (see Patent Reference 1 listed below). Therefore, Patent Reference 1 has the same problems as those of FIG. 1.

Next, FIG. 2 is a background art view showing a typical example of the structure of a damage control device by a power control mechanism. In the structure example of the damage control device shown in FIG. 2, a power control mechanism 1000 is provided in addition to the structure of FIG. 1.

In such a structure, the CPU 10P1 shuts off the power of the CPU that is under no load (the CPU 10P2 in FIG. 2) through the power control mechanism 1000. Thereby, the damage to the CPU that is under no load can be reduced.

However, the method shown in FIG. 2 has the following problems in addition to the problems shown in FIG. 1.

Firstly, since the CPU that performs power control is fixed, it is difficult to reduce the damage to the CPU.

Secondly, advantages of this method can be enjoyed only under no load.

As a technique to handle these, Patent Reference 2 (Japanese Unexamined Patent Application Publication No. 2004-355153) discloses a power management system using an OS for single processors (see Patent Reference 2 listed below). However, Patent Reference 2 discloses a similar structure to that shown in FIG. 2. Therefore, Patent Reference 2 has the same problems as those of FIG. 2.

Patent Reference 1: Japanese Unexamined Patent Application Publication No. S62-075739

Patent Reference 2: Japanese Unexamined Patent Application Publication No. 2004-355153

### DISCLOSURE OF THE INVENTION

### Problems to be Solved by the Invention

As described above, it has conventionally been impossible to realize the prolongation of the useful life of the semiconductor integrated circuit including a plurality of CPUs by dispersing a damage evenly to the CPUs.

Further, it has been difficult to move the execution environments of during operation among the CPUs.

Here, the execution environment refers to an application execution environment of not only an application but also an OS and middleware.

### Object of the Invention

Accordingly, an object of the present invention is to provide a semiconductor integrated circuit, a semiconductor integrated circuit control device, a load distribution method, a load distribution program and an electronic apparatus in which in a semiconductor integrated circuit including a plurality of arithmetic units, a damage to the arithmetic units is dispersed with a higher accuracy than in the conventional technique.

### Means for Solving the Problem

The invention attaining the above-mentioned object is characterized by a semiconductor integrated circuit including a plurality of arithmetic units capable of operating by means of a program, the semiconductor integrated circuit including a damage control unit that controls switching of execution environments of the arithmetic units, wherein the damage control unit includes: a switching judgment unit that calculates load conditions on the arithmetic units; and a switching unit that switches the execution environments operating on the arithmetic units, based on a result of the calculation by the switching judgment unit.

(Workings)

By the above-described structure, for the semiconductor integrated circuit including a plurality of arithmetic units capable of operating by means of a program, not the load distribution is performed only at application level but the execution environment, including the OS, itself can be moved.

### EFFECTS OF THE INVENTION

According to the present invention, since the execution environment, including the OS, itself can be moved to enable a more accurate load distribution of arithmetic units and the cumulative damages to the arithmetic units can be controlled for each arithmetic unit, the damage to the semiconductor integrated circuit can be more smoothed, so that the useful life of the semiconductor integrated circuit can be prolonged.

The reason therefor is that the damage control unit that controls the execution environment switching among the plurality of arithmetic units capable of operating by means of a program calculates the conditions of the loads on the arithmetic units and switches the execution environments operating on the arithmetic units based on the result of the calculation.

### BEST MODE FOR CARRYING OUT THE INVENTION

A best mode for carrying out the present invention will be described.

The present invention is, according to a preferred embodiment thereof, referring to FIG. 3, provided with: damage control means 100 for performing damage control of a plurality of CPUs 10P1 to 10Pn in addition to a semiconductor integrated circuit including the CPU 10P1 to 10Pn, an accelerator 50, a ROM 51, a RAM 52, an I/O 53, an interrupt/clock/power controller 54 and a timer 55, connected through a system bus 60.

Thereby, the damage control means 100 can judge the switching of the execution environment for performing damage dispersion based on the damage information and move the context of the execution environment from a CPU to another CPU based on the judgment.

More specifically, for example, it is possible to switch the execution environment so that the damage is equalized among the CPUs. Moreover, for example, it is possible to set a damage threshold value for each CPU and switch the execution environment so that the damage of each CPU approaches the threshold value. Moreover, for example, it is possible to set the damage threshold value of a specific CPU to a value lower than that of the other CPUs and switch the execution environment so that the damage of the specific CPU does not exceed the threshold value.

Consequently, a more accurate CPU load distribution can be performed, and at the same time, the cost of the software modification can be suppressed to be small.

Hereinafter, detailed description will be given by using drawings according to exemplary embodiments.

### First Exemplary Embodiment

A first exemplary embodiment of the present invention will be described in detail with reference to the drawings. In the present embodiment, the execution environment is switched so that the damage is equalized among the CPUs.

(Structure of the First Exemplary Embodiment)

FIG. 3 is a block diagram showing the structure of a damage control device of a semiconductor integrated circuit according to the first exemplary embodiment of the present invention.

Referring to FIG. 3, the damage control device of the semiconductor integrated circuit of the present embodiment is provided with the damage control means 100 for performing damage control of a plurality of CPUs in addition to the semiconductor integrated circuit including the CPUs 10P1 to 10Pn, the accelerator 50, the ROM 51, the RAM 52, the input/output (I/O) 53, the interrupt/clock/power controller 54 and the timer 55, connected through the system bus 60.

The CPUs 10P1 to 10Pn, the accelerator 50, the ROM 51, the RAM 52, the I/O 53, the interrupt/clock/power controller 54, the timer 55 and the damage control means 100 of the present embodiment may each have not only a separate package structure but also a circuit structure in a SoC (System-on-Chip), a SiP (System-in-Package) structure by a separate chip, or a combination thereof.

The CPUs 10P to 1-Pn according to the present embodiment may be any arithmetic units that are capable of program operation such as signal processors, VLIW processors or configurable processors.

The damage control means 100 according to the present embodiment may be implemented not only as a hardware structure but also as a software structure.

The damage to the CPUs is calculated from phenomena that cause an aged deterioration as mentioned below in the semiconductor device. Examples of such phenomena include electromigration and stressmigration of wiring, time dependent oxide breakdown of transistors, NBTI (negative bias temperature instability) and hot carrier injection. These phenomena have a characteristic that the mean failure rate varies according to the temperature, the gate-source voltage or the like. Therefore, an index calculated from values such as the temperature, voltage, current consumption amount, operation ratio, the number of accesses to the resources in the CPU and the like at a given point of time will hereinafter be referred to a damage ratio.

For the damage ratio, the above-mentioned values are calculated or observed by the damage control means based on the information on the phenomena as mentioned above. The measurement of the temperature, voltage and power consumption may be converted from a measurement device provided in itself, a measurement device of the semiconductor integrated circuit or the internal load information. In any case, they can be obtained based on information from a conventional measurement device.

FIG. 4 is a view showing an example of the operating environments of the damage control device of the semiconductor integrated circuit according to the present embodiment. An operating environment diagram 201 shows the operating environments of the semiconductor integrated circuit at a time T, and an execution environment-damage ratio information 202 shows the execution environments operating at the time T and the damage ratios at the time T with respect to the CPUs.

Referring to the operating environment diagram 201, at the time T, an execution environment 40P1 including the OS 20P1 and a plurality of applications 30P1 and 30P2 is operating on the CPU 10P1, an execution environment 40P2 including the OS 20P2 and an application 30P3 is operating on the CPU 10P2, and an execution environment 40Pn including the OS 20Pn and an application 30Pm is operating on the CPU 10Pn.

Referring to the execution environment-damage ratio information 202, it is apparent that at the time of the operation (time T), the damage ratio of the CPU 10P1 on which the execution environment 40P1 is operating is 60%, the damage ratio of the CPU 10P2 on which the execution environment 40P2 is operating is 30%, the damage ratio of the CPU 10P3 on which the execution environment 40P3 is operating is 5%, and the damage ratio of the CPU 10Pn on which the execution environment 40Pn is operating is 25%.

Assume now that the damage ratio is the same for the time being. Then, the damage control device according to the present embodiment changes the configurations of the execution environments 40P1 to 40Pn based on the damage ratios.

FIG. 5 is a view showing an example of the operating environments of the damage control device of the semiconductor integrated circuit according to the present embodiment. An operating environment 301 shows the operating environments of the semiconductor integrated circuit at a time T+δT, and an execution environment-damage ratio information 302 shows the execution environments operating at the time T and the time T+δT, the damage ratios at the time T and the time T+δT and the cumulative sums of the damage ratios at the time T and the time T+δT with respect to the CPUs.

Referring to the operating environment diagram 301, by the damage control device, the execution environments at the time T in the operating environment diagram 201 are moved as follows at the time T+δ T: The execution environment 40P1 is moved to the CPU 10P3; the execution environment 40P2, to the CPU 10Pn; the execution environment 40P3, to the CPU 10P1; and the execution environment 40Pn, to the CPU10P2.

Referring to the execution environment-damage ratio information 302, the cumulative sums of the damage ratios at the CPUs is as follows: 65% at the CPU 10P1; 55% at the CPU 10P2; 65% at the CPU 10P3; and 55% at the CPU 10Pn.

Thereby, the cumulative sums of the damage ratios at the CPUs can be smoothed.

While judgment is made based on the damage ratios at a given point of time in this example, it is to be noted that judgment may be made based on the cumulative damage ratios. That is, judgment may be made based on a combination of the current cumulative damage ratios and the damage ratios at a given time. In addition, any method is applicable as long as it is a calculation method that is useful for smoothing dynamically varying numerical values.

FIG. 6 is a block diagram showing a structure example of the damage control means of the semiconductor integrated circuit according to the present embodiment.

Referring to FIG. 6, the damage control means 100 is provided with: switching judgment means 110 including a function to judge the CPU configuration which performs smoothing of the damage ratio, according to the damage ratio of all or some of the CPUs; and switching means 120 including a function to perform switching of the input/output signals of all the CPUs.

The switching judgment means 110 observes the damage ratio as an index calculated from values such as the temperature, voltage, current consumption amount, operation ratio, the number of accesses to the resources in the CPU and the like at all times or at some extent of time intervals. Then, using the calculation method for smoothing the damage ratios of the CPUs, the switching judgment means 110 notifies the switching means 120 of the CPU configuration to be changed. However, since the switching means 120 cannot always switch the execution environment 40 at a given point of time, the switching judgment means 110 may provide the notification to the switching means 120 after a stable condition where the execution environment 40 is switchable such as a condition where the internal caches are flushed or a condition where interrupt processing with an external I/O is completed is brought about, by cooperating with the execution environment 40.

The switching means 120 makes a connection to the input/output signals of all the CPUs and the system bus 60, and switches the input/output signal of the CPU to be switched, according to the notification from the switching judgment means 120. The object of the switching by the switching means 120 may be not only the instruction/data bus but also input/output signals including general signals such as a clock/reset signal and an interrupt signal.

Moreover, the switching means 120 includes a function related to the setting and extraction of the context of the currently executed execution environment of each CPU.

By these functions, the switching means 120 can switch the execution environment operating on one CPU to another CPU.

Here, the context is information representative of the storage condition, at a specified instant, of an operating CPU.

FIG. 7 is a view showing a structure example of the switching means of the semiconductor integrated circuit according to the present embodiment.

Referring to FIG. 7, the switching means 120 is provided with: context setting and extraction means 121 including a function to set and extract the contexts of the execution environments of the CPUs; and signal connection means 122 including a function to switch the connection of the input/output signals to the CPUs, in cooperation with the context setting and extraction means 121.

The context setting and extraction means 121 is connected to the switching judgment means 110. When accepting a switching request from the switching judgment means 110, the context setting and extraction means 121 sets and extracts the contexts through the system bus 60 connected to the CPUs 10P1 to 10Pn, and holds the extracted contexts. Further, the context setting and extraction means 121 notifies the signal connection means 122 of an instruction to start and stop switching.

The signal connection means 122 is connected to the CPUs 10P1 to 10Pn and the system bus 60, and switches the signal connection according to the instruction from the context setting and extraction means 121.

In the present embodiment, the context setting and extraction means 121 can be implemented either by a hardware structure or by a software structure. The context setting and extraction means 121 may have any structure as long as it is implemented by a conventional context setting and extraction technique such as a conventional technique of obtaining all the data in the CPUs by using a scan chain in the case of a hardware structure or a conventional technique of setting and saving data by an operation on a hypervisor mode that the CPU is provided with in the case of a software structure.

Moreover, the signal connection means 122 may be implemented not only by the switching of all the signals which is a hardware manner but also by resetting pieces of information necessary for causing the execution environments to operate in a software manner such as changing the interrupt destination or changing the processor number.

In the damage control device of the semiconductor integrated circuit according to the present invention, not only its operation is implemented in a hardware manner by providing a circuit part configured by a hardware part such as an LSI (large scale integration) incorporating a program to implement such a function in the damage control device but also the operation may be implemented in a software manner by executing a program providing the function of each of the above-described components by the CPU 10 on a computer processor.

That is, the CPU 10 (the CPU 10, the CPUs 10P1 to 10Pn) loads a program stored in the ROM 51, into the main memory, executes it, and controls the operation of the damage control device, whereby the above-mentioned functions can be implemented in a software manner.

(Operation of the First Exemplary Embodiment)

Next, the operation of the damage control device of the semiconductor integrated circuit according to the present embodiment will be described.

FIG. 8 is a flowchart showing the operation of the damage control device of the semiconductor integrated circuit according to the present embodiment.

Referring to FIG. 8, in the damage control device according to the present embodiment, the switching judgment means 110 observes the damage ratios at all times or at some extent of time intervals (step S101), judges the CPU configuration to be changed, by using the calculation method for smoothing the damage ratios of the CPUs (step S102), and notifies the switching means 120 of the CPU configuration to be changed (step S103).

Then, the switching means 120 extracts and sets the context of the currently executed execution environment of the CPU concerned, based on the notification from the switching judgment means 110 (step S104), and switches the input/output signal of the CPU to be switched (step S105).

FIG. 9 is a view for explaining an example of the operation of the switching means 120 of FIG. 7. In FIG. 9, the reference designations configured by a letter S and a numeral beside the arrows represent step numbers. In this example, a method for moving the execution environment by context setting and extraction will be described.

First, it is assumed that no switching is occurring.

Step S201: The context setting and extraction means 121 accepts an instruction to switch between the CPU 10P2 and the CPU 10Pn from the switching judgment means 110.

Step S202: The context setting and extraction means 121 requests the signal connection means 122 to stop the delivery of signals such as a reset signal and an interrupt signal. In this case, the context setting and extraction means 121 may permit the signal connection means 122 to input and output signals related to the context setting and extraction.

Step S203: The context setting and extraction means 121 extracts (reads) the context from the CPU 10P2, and temporarily stores it in context storage means 123.

Step S204: The context setting and extraction means 121 reads the context from the CPU 10Pn, temporarily stores it in the context storage means 123, and sets the context of the CPU 10P2 stored at step S203, to the CPU 10Pn.

Step S205: The context setting and extraction means 121 sets the context of the CPU 10Pn stored at step S204, to the CPU 10P2.

Step S206: When the context setting is finished, the context setting and extraction means 121 instructs the signal connection means 122 to perform signal switching.

Step S207: When receiving the switching instruction from the context setting and extraction means 121, the signal connection means 122 switches signal connection as if a signal from the CPU 10P2 were connected as the CPU 10Pn from the system bus 60, and switches signal connection as if a signal of the CPU 10Pn were connected as the CPU 10P2 from the system bus 60.

FIG. 10 is a view for explaining an example of the operation of the switching means 120 of FIG. 7. In FIG. 10, the reference designations configured by a letter S and a numeral beside the arrows represent step numbers. In this example, the signal line connection condition after the context setting and extraction will be described.

First, it is assumed that no switching is occurring.

Step S301: The context setting and extraction means 121 instructs the signal connection means 122 to perform connection switching between the CPU 10P2 and the CPU 10P4, and the signal connection means 122 switches the signal line according to the instruction.

Step S302: The signal connection means 122 accepts the input signal to the CPU 10P2, from the system bus 60.

Step S303: The signal connection means 122 transfers the signal to the CPU 10Pn.

Step S304: The signal connection means 122 accepts the input signal to the CPU 10Pn, from the system bus 60.

Step S305: The signal connection means 122 transfers the signal to the CPU 10P2.

FIG. 11 is a view for explaining an example of the operation of the damage control means 100 of FIG. 6. In FIG. 11, the reference designations configured by a letter S and a numeral beside the arrows represent step numbers. In this example, the whole of the operation described with reference to FIGS. 9 and 10 is shown.

First, it is assumed that no switching is occurring.

Step S401: The switching means 120 accepts the signal to the CPU 10P2, from the system bus 60.

Step S402: The switching means 120 passes the signal to the CPU 10P2.

Step S403: The switching judgment means 110 notifies the switching means 120 that the execution environment on the CPU 10P2 is moved to the CPU 10Pn based on the calculation of the damage ratio. Based on the notification, the switching means 120 interchanges the contexts of the CPU 10P2 and the CPU 10Pn, and switches signal connection as if connection were switched from the system bus 60.

Step S404: The switching means 120 accepts the signal to the CPU 10P2, from the system bus 60.

Step S405: The switching means 120 passes the signal to the CPU 10Pn.

(Effects of the First Exemplary Embodiment)

According to the present invention, not the load distribution is performed only at application level but the execution environment, including the OS, itself can be moved for the semiconductor integrated circuit including a plurality of CPUs, so that the cumulative damages to the CPUs can be more smoothed.

The reason therefor is that the damage control means according to the present embodiment is provided with: the switching judgment means 110 for observing the damage ratio as an index calculated from values such as the temperature, voltage, current consumption amount, operation ratio, the number of accesses to the resources in the CPU and the like at all times or at some extent of time intervals, and notifying the switching means 120 of the CPU configuration to be changed, by using the calculation method for smoothing the damage ratios of the CPUs; and the signal connection means 122 for setting and extracting the context of the execution environment of the CPU, and switching connection of the input/output signal to the CPU based on the switching request from the switching judgment means 110.

Moreover, according to the present invention, in the mode in which the present invention is implemented by hardware, the damage smoothing can be realized with minimum modification of existing software.

### Second Exemplary Embodiment

Next, a damage control device of a semiconductor integrated circuit according to a second exemplary embodiment of the present invention will be described with reference to the drawings. Since the present embodiment is different from the first exemplary embodiment in the damage control means 120, the difference will be mainly described in the following:

(Structure of the Second Exemplary Embodiment)

FIG. 12 is a view showing a structure example of the damage control means of the semiconductor integrated circuit according to the present embodiment.

Like the damage control means 100 according to the first exemplary embodiment, the damage control means 100 according to the present embodiment is provided with: the switching judgment means 110 including a function to consider the CPU configuration which performs smoothing of the damage ratio, according to the damage ratios of all or some of the CPUs; and the switching means 120 including a function to switch the input/output signals of all the CPUs.

For this reason, the switching judgment means 110 according to the present embodiment has the same characteristics as the switching judgment means 110 according to the first exemplary embodiment described with reference to FIGS. 6 and 11.

However, the switching judgment means 110 according to the present embodiment is different from the switching judgment means 110 according to the first exemplary embodiment in that it is implemented as software on the CPUs 10P1 to 10Pn. Here, the switching judgment means 110 according to the present embodiment may be implemented as a so-called application, library, task, thread or process, may be implemented as an OS module or a device driver, or may be implemented in a new mode of the CPU such as hypervisor mode having higher priority than user/supervisor mode.

While the switching means 120 according to the present embodiment has the same characteristics as the switching means 120 according to the first exemplary embodiment described with reference to FIGS. 6 and 11, it is different from the switching means 120 according to the first exemplary embodiment in that it cooperates with the switching judgment means 110 according to the present embodiment implemented as software.

(Effects of the Second Exemplary Embodiment)

According to the present invention, in addition to the effects of the first exemplary embodiment, the execution environment including the switching judgment means 110 implemented as software on the CPUs 10P1 to 10Pn can be moved, so that the cumulative damages to the CPUs can be more smoothed than in the first exemplary embodiment.

### Third Exemplary Embodiment

Next, a damage control device of a semiconductor integrated circuit according to a third exemplary embodiment of the present invention will be described with reference to the drawings. Since the present embodiment is different from the first exemplary embodiment in the switching means 120, the difference will be mainly described in the following:

(Structure of the Third Exemplary Embodiment)

FIG. 13 is a view showing a structure example of the damage control means of the semiconductor integrated circuit according to the present embodiment.

Like the damage control means 100 according to the first and second exemplary embodiments, the damage control means 100 according to the present embodiment is provided with: the switching judgment means 110 including the function to consider the CPU configuration which performs smoothing of the damage ratio, according to the damage ratios of all or some of the CPUs; and the switching means 120 including the function to switch the input/output signals of all the CPUs.

Moreover, like the switching judgment means 110 according to the second exemplary embodiment described with reference to FIG. 12, the switching judgment means 110 according to the present embodiment is implemented as software.

For this reason, the switching judgment means 110 according to the present embodiment has the same characteristics as the switching judgment means 110 according to the second exemplary embodiment described with reference to FIG. 12.

The switching means 120 according to the present embodiment is different from the switching means 120 according to the first exemplary embodiment in that it is implemented as software on the CPUs 10P1 to 10Pn. Here, the switching means 120 according to the present embodiment may be implemented as a so-called application, library, task, thread or process, may be implemented as an OS module or a device driver, or may be implemented in a new mode of the CPU such as hypervisor mode.

The switching means 120 according to the present embodiment cannot switch all the input/output signals since it is implemented as software. Therefore, the switching means 120 according to the present embodiment handles this by resetting pieces of information necessary for causing the execution environments to operate in a software manner such as changing the interrupt destination or changing the processor number.

(Effects of the Third Exemplary Embodiment)

According to the present embodiment, in addition to the effects of the first exemplary embodiment, the execution environment including the switching means 120 implemented as software on the CPUs 10P1 to 10Pn can be moved, so that the cumulative damages to the CPUs can be more smoothed than in the first exemplary embodiment.

While the present invention has been described with reference to the preferred embodiments, the present invention is not necessarily limited to the above-described embodiments; it is to be understood that various alterations and modifications that one of ordinary skill in the art can make within the scope of the present invention are included and the present invention may be altered variously within the scope of the technical ideas thereof.

While the above-described embodiments have been described by taking, as an example, the damage control device and method for controlling the damage to the semiconductor integrated circuit including a plurality of CPUs, the present invention is not limited to such a damage control device and method but is applicable to an arbitrary damage control device and method.

This application is based upon and claims the benefit of priority from Japanese patent application No. 2006-332121, filed on Dec. 8, 2006, the disclosure of which is incorporated herein in its entirety by reference.

### BRIEF DESCRIPTION OF THE DRAWINGS

FIG. 1 A view showing the structure example of the conventional damage control device.

FIG. 2 A view showing the structure example of the conventional damage control device.

FIG. 3 A block diagram showing the structure of the damage control device of the semiconductor integrated circuit according to the first exemplary embodiment of the present invention.

FIG. 4 A view showing the example of the operating environments of the damage control device of the semiconductor integrated circuit according to the first exemplary embodiment.

FIG. 5 A view showing the example of the operating environments of the damage control device of the semiconductor integrated circuit according to the first exemplary embodiment.

FIG. 6 A block diagram showing the structure example of the damage control means of the semiconductor integrated circuit according to the first exemplary embodiment.

FIG. 7 A view showing the structure example of the switching means of the semiconductor integrated circuit according to the first exemplary embodiment.

FIG. 8 A flowchart showing the operation of the damage control device of the semiconductor integrated circuit according to the present embodiment.

FIG. 9 A view for explaining the operation of the switching means according to the first exemplary embodiment.

FIG. 10 A view for explaining the operation of the switching means according to the first exemplary embodiment.

FIG. 11 A view for explaining the operation of the damage control means according to the first exemplary embodiment.

FIG. 12 A block diagram showing the structure of the damage control device of the semiconductor integrated circuit according to the second exemplary embodiment of the present invention.

FIG. 13 A block diagram showing the structure of the damage control device of the semiconductor integrated circuit according to the third exemplary embodiment of the present invention.

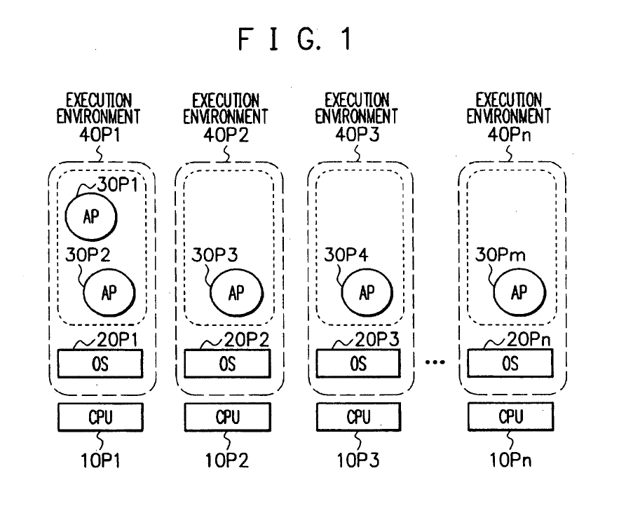

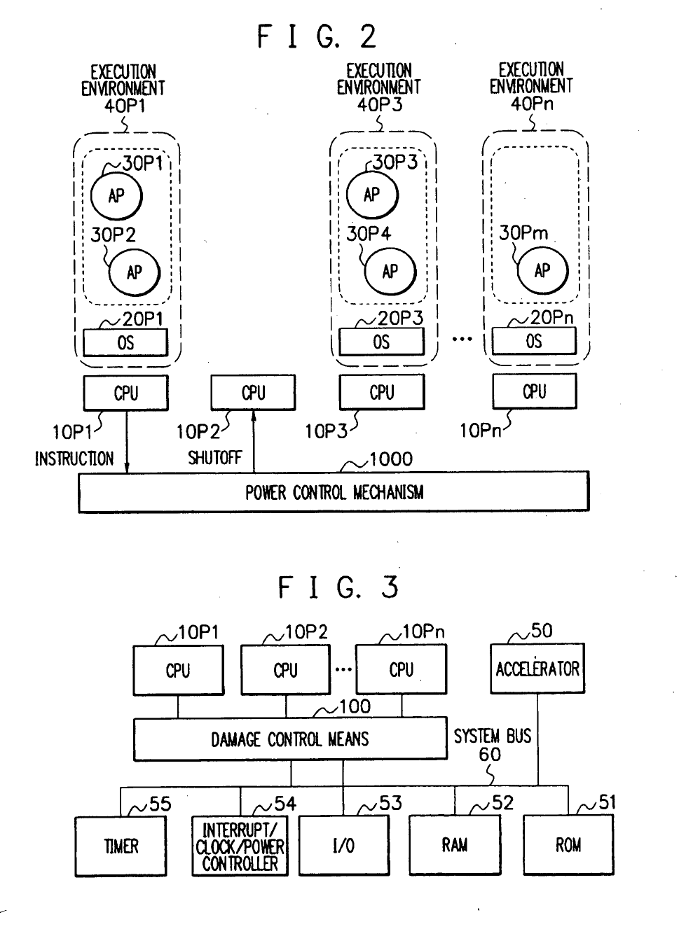

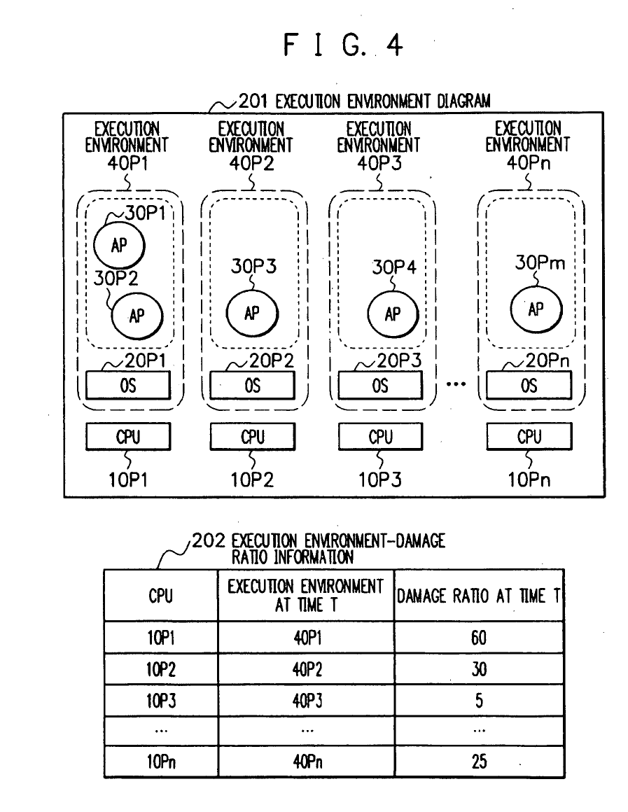

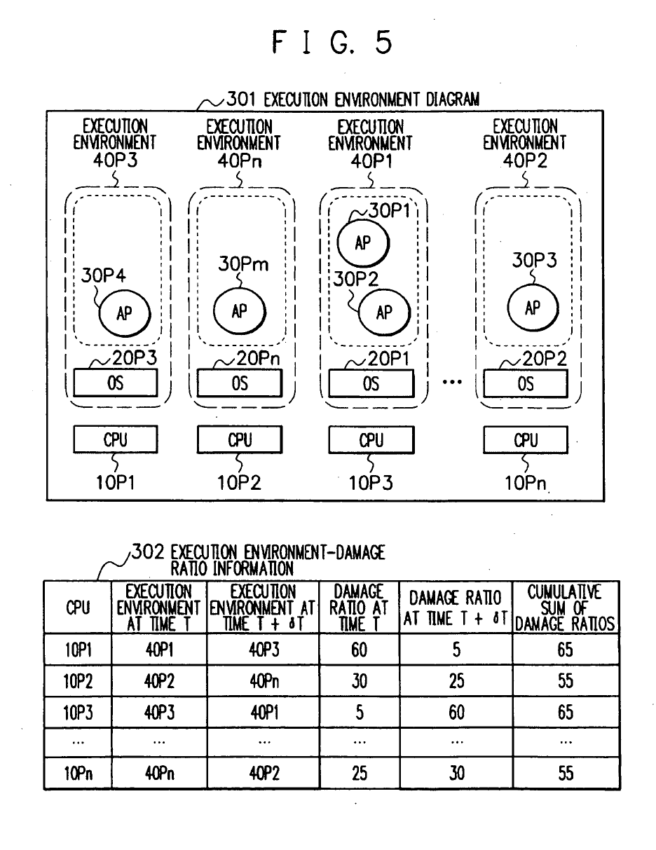

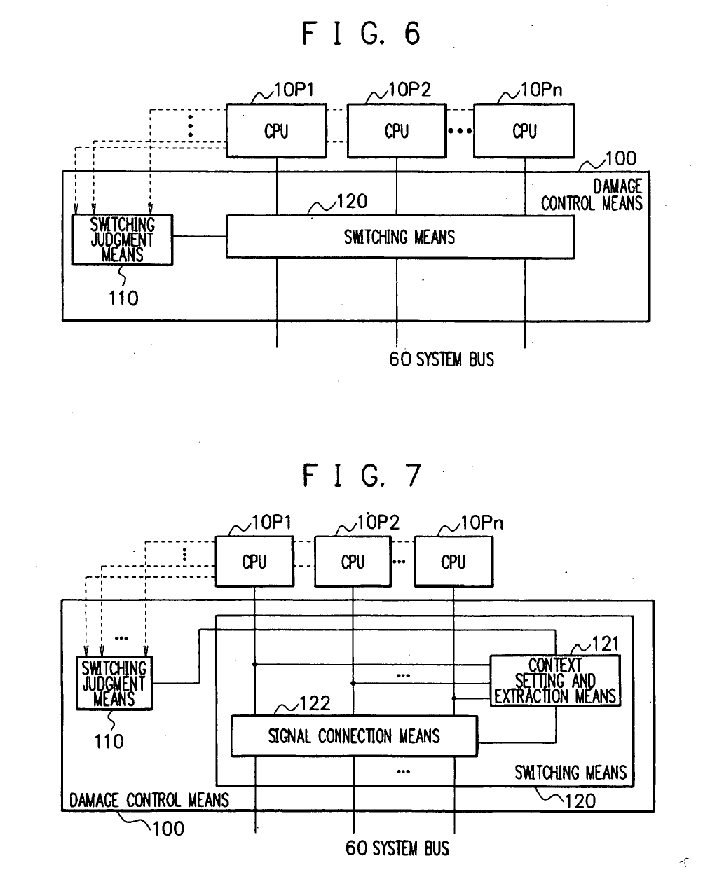

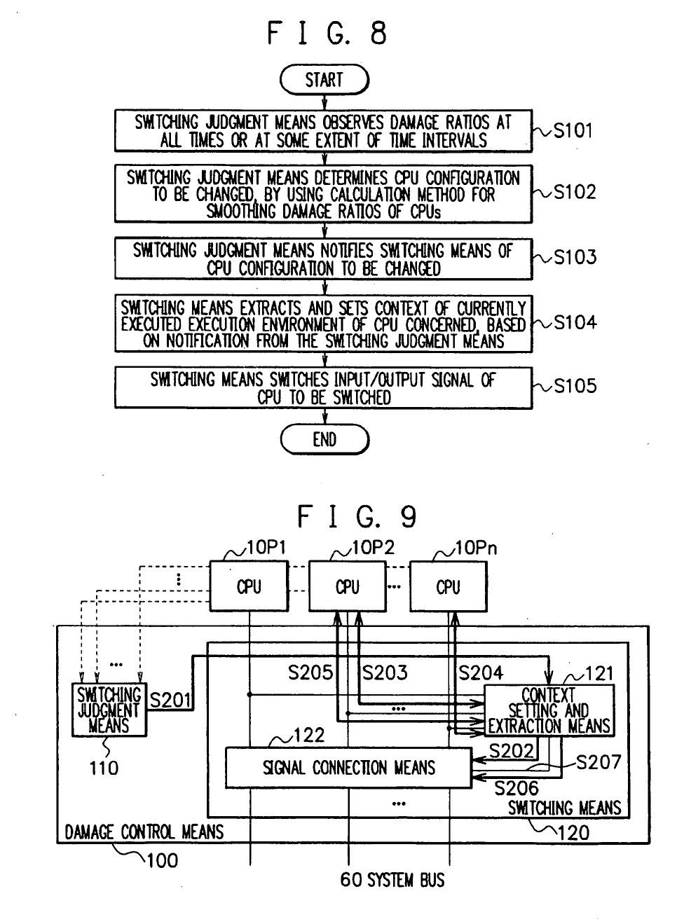

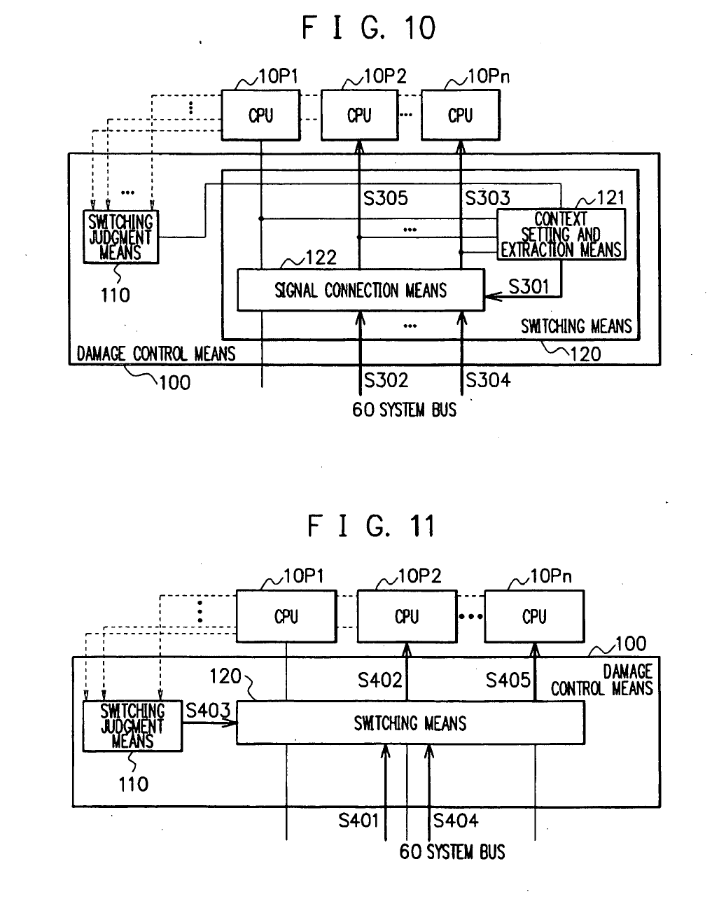

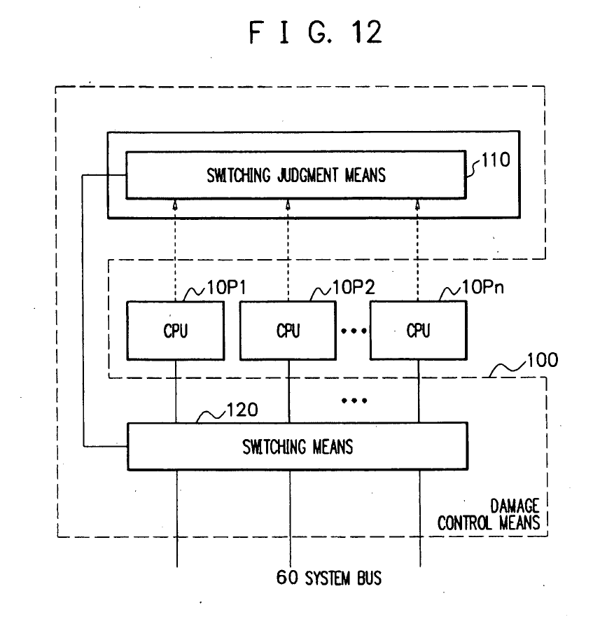

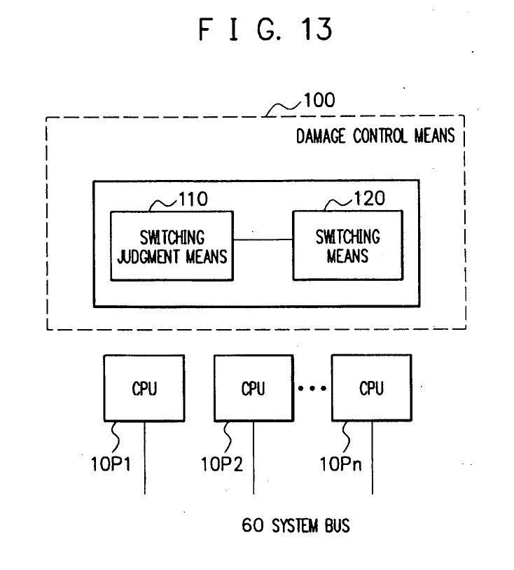

### EXPLANATION OF REFERENCE DESIGNATIONS

10, 10P1, 10P2, 10P3-10Pn CPU
20, 20P1, 20P2, 20P3-20Pn OS
30, 30P1, 30P2, 30P3-30Pm Application (AP)
40, 40P1, 40P2, 40P3, 40Pn Execution environment
50 Accelerator
51 ROM
52 RAM
53 I/O
54 Interrupt/clock/power controller
55 Timer
60 System bus
100 Damage control means
110 Switching judgment means
120 Switching means
121 Context setting and extraction means
122 Signal connection means
1000 Power control mechanism

1-24. (canceled)

25. A semiconductor integrated circuit including a plurality of arithmetic units capable of operating by means of a program, the semiconductor integrated circuit comprising a damage control unit that controls switching of execution environments of the arithmetic units,
wherein the damage control unit includes:
a switching judgment unit that calculates cumulative sums of load conditions on the arithmetic units; and
a switching unit that switches the execution environments operating on the arithmetic units, based on a result of the calculation by the switching judgment unit, and
the switching unit includes: a context setting and extraction unit that sets or extracts contexts of the execution environments of the arithmetic units; and a signal switching unit that switches a signal connection according to an instruction to start and stop switching of the contexts.

26. The semiconductor integrated circuit according to claim 25, wherein the switching judgment unit calculates the cumulative sums of the load conditions based on damage ratios of the arithmetic units, and judges a necessity of the switching of the execution environments.

27. The semiconductor integrated circuit according to claim 26, wherein the damage ratios are derived based on a phenomenon that brings about an aged deterioration of the arithmetic units.

28. The semiconductor integrated circuit according to claim 27, wherein the context setting and extraction unit switches the contexts of the execution environments by the setting or extraction, and the signal switching unit switches the signal connection in correspondence with the switched contexts.

29. The semiconductor integrated circuit according to claim 25, wherein the switching judgment unit judges the switching of the execution environments so that the cumulative sums of the load conditions of the arithmetic units are equalized, based on the calculated cumulative sums of the load conditions.

30. The semiconductor integrated circuit according to claim 25, wherein the switching judgment unit judges the switching of the execution environments so that the cumulative sums of the load conditions of the arithmetic units approach threshold values set for the arithmetic units, respectively, based on the calculated cumulative sums of the load conditions.

31. A semiconductor integrated circuit control device that controls, on a semiconductor integrated circuit including a plurality of arithmetic units capable of operating by means of a program, the arithmetic units, the semiconductor integrated circuit control device comprising: a damage control unit that controls switching of execution environments of the arithmetic units, wherein the damage control unit includes: a switching judgment unit that calculates cumulative sums of load conditions on the arithmetic units; and a switching unit that switches the execution environments operating on the arithmetic units, based on a result of the calculation by the switching judgment unit, and
the switching unit includes: a context setting and extraction unit that sets and extracts contexts of the execution environments of the arithmetic units; and a signal switching unit that switches a signal connection according to an instruction to start and stop switching of the contexts.

32. The semiconductor integrated circuit control device according to claim 31, wherein the switching judgment unit calculates the cumulative sums of the load conditions based on damage ratios of the arithmetic units, and judges a necessity of the switching of the execution environments.

33. The semiconductor integrated circuit control device according to claim 32, wherein the damage ratios are derived based on a phenomenon that brings about an aged deterioration of the arithmetic units.

34. The semiconductor integrated circuit control device according to claim 33, wherein the context setting and extraction unit switches the contexts of the execution environments by the setting or extraction, and
the signal switching unit switches the signal connection in correspondence with the switched contexts.

35. The semiconductor integrated circuit control device according to claim 31, wherein the switching judgment unit judges the switching of the execution environments so that the cumulative sums of the load conditions of the arithmetic units are equalized, based on the calculated cumulative sums of the load conditions.

36. The semiconductor integrated circuit control device according to claim 31, wherein the switching judgment unit judges the switching of the execution environments so that the cumulative sums of the load conditions of the arithmetic units approach threshold values set for the arithmetic units, respectively, based on the calculated cumulative sums of the load conditions.

37. The semiconductor integrated circuit control device according to claim 31, wherein the semiconductor integrated circuit is included.

38. A method for distributing loads on a plurality of arithmetic units capable of operating by means of a program, the method comprising:
a calculation step of calculating a cumulative sum of a load condition of one or more than one of the arithmetic units;
a judgment step of judging to which of the other arithmetic units an execution environment of the arithmetic unit is switched, according to the cumulative sum of the load condition; and
a switching step of switching the execution environment of the arithmetic unit to the other arithmetic unit based on a result of the judgment,
wherein in the switching step, a context of the execution environment of the arithmetic unit is set or extracted, and a signal connection is switched according to an instruction to start and stop switching of the context.

39. The method for distributing the loads on the arithmetic units according to claim 38, wherein a damage ratio of the arithmetic unit is calculated, and the cumulative sum of the load condition is calculated based on the damage ratio.

40. The method for distributing the loads on the arithmetic units according to claim 39, wherein the damage ratio is calculated based on a phenomenon that brings about an aged deterioration of the arithmetic unit.

41. The method for distributing the loads on the arithmetic units according to claim 40, wherein the context of the execution environment is switched by the setting or extraction, and
the signal connection is switched in correspondence with the switched context.

42. The method for distributing the loads on the arithmetic units according to claim 38, wherein the switching of the execution environment is judged so that the cumulative sums of the load conditions of the arithmetic units are equalized, based on the calculated cumulative sums of the load conditions.

43. The method for distributing the loads on the arithmetic units according to claim 38, wherein the switching of the execution environment is judged so that the cumulative sums of the load conditions of the arithmetic units approach threshold values set for the arithmetic units, respectively, based on the calculated cumulative sums of the load conditions.

44. A computer-readable medium storing a program for distributing loads on a plurality of arithmetic units capable of operating on a computer by means of a program, the program causing damage control unit to execute:
a processing of calculating a cumulative sum of a load condition of one or more than one of the arithmetic units; and
a processing of judging to which of the other arithmetic units an execution environment of the arithmetic unit is switched, according to the cumulative sum of the load condition, and
the program causing switching unit to execute:
a context setting and extraction processing of setting or extracting a context of the execution environment of the arithmetic unit, and
a signal switching processing of switching a signal connection according to an instruction to start and stop switching of the context.

45. An electronic device comprising the semiconductor integrated circuit according to claim 25.

46. A semiconductor integrated circuit including a plurality of arithmetic units capable of operating by means of a program, the semiconductor integrated circuit comprising damage control means for controlling switching of execution environments of the arithmetic units,
wherein the damage control means includes:
switching judgment means for calculating cumulative sums of load conditions on the arithmetic units; and
switching means for switching the execution environments operating on the arithmetic units, based on a result of the calculation by the switching judgment means, and
the switching means includes: context setting and extraction means for setting or extracting contexts of the execution environments of the arithmetic units;
and signal switching means for switching a signal connection according to an instruction to start and stop switching of the contexts.

47. A semiconductor integrated circuit control device that controls, on a semiconductor integrated circuit including a plurality of arithmetic units capable of operating by means of a program, the arithmetic units, the semiconductor integrated circuit control device comprising: damage control means for controlling switching of execution environments of the arithmetic units, wherein the damage control means includes: switching judgment means for calculating cumulative sums of load conditions on the arithmetic units; and switching means for switching the execution environments operating on the arithmetic units, based on a result of the calculation by the switching judgment means, and
the switching means includes: context setting and extraction means for setting or extracting contexts of the execution environments of the arithmetic units; and signal switching means for switching a signal connection according to an instruction to start and stop switching of the contexts.
